(19) United States
(12) Patent Application Publication
(10) Pub. No.: US 2002/0049765 A1
(43) Pub. Date: Apr. 25, 2002

(54) Information system

(75) Inventor: Toshihiro Aruga, Tokyo (JP)

Correspondence Address: David A. Blumenthal, FOLEY & LARDNER, Suite 500, 3000 K Street, N.W., Washington, DC, 20007-5109, US

(73) Assignee: NEC CORPORATION.

(21) Appl. No.: 09/983,170

(22) Filed: Oct. 23, 2001

(30) Foreign Application Priority Data
Oct. 24, 2000 (JP) 2000-323861

(51) Int. Cl. G06F 7/00

(52) U.S. Cl. 707/100; 707/200

(57) ABSTRACT

An information system includes a first terminal which is used by an information supplier to enter information about a state around a present location of the information supplier, a second terminal which is used by an information requester who wants to obtain the information entered by the information supplier, and a server which is connected to the first terminal and the second terminal and controls transmission of information between the terminals. In response to a request of the information requester, the second terminal displays a list of the information suppliers who can supply information about a location designated by the requester. The requester selects an information supplier from the list and then the server transmits the information supplied from the information supplier using the first terminal to the first terminal.

### BACKGROUND OF THE INVENTION

1. Field of the Invention

The invention relates to an information system which can provide a person who wants to get information about a place with information about the place, from an information supplier who resides or stays at the place.

2. Description of the Related Art

In recent years, web sites are increased in number, among which a scene or a landscape of a specified place or a noted place can be transmitted in the form of a moving picture, a still image, or a sound, in real-time. As a background of this increase, consideration may be made about several factors, such as recent spread of the Internet, improvement of a performance of server computers, and an expansion of a bandwidth of a communication line.

For example, images of Mt. Fuji is taken by a camera at a fixed point and the images are provided as a plurality of still images in a predetermined interval. Alternatively, images and sound around a station are taken by a camera and a microphone incorporated in the camera, respectively, and they are provided in real-time via a web site on the Internet.

In particular, in a web site providing a moving picture or a still image, a camera which is connected to the Internet is often used. The camera is referred to as a “live camera”. Also, in some web sites, the live camera is controlled to change a direction of the camera by a person who browses one of the web sites (that is, a user of the Internet) through the Internet, with browsing the web site.

Thus, the user of the Internet can show (or hear) images (or a sound) of a specified place by using the web site.

However, in the above mentioned web sites, the images and a sound are substantially provided without obtaining any fee from an audience. Some of the web sites are indirectly managed based on an income of an advertisement. Also, the others of the web sites does not aim for any types of incomes. Therefore, administrator of such the web site must bear costs of installation and management of a live camera, a server computer, and a communication line. As a result, it is impossible to install a large number of live cameras and thereby the amount of information obtained from the live cameras is limited to some extent.

### SUMMARY OF THE INVENTION

Therefore, it is an object of the invention to provide a system which supplies various information including images or a sound at various places.

Further, it is an object of the invention to provide a system which provides a person who wants to get information about a place with states, images, or a sound at the place, from an information supplier who is registered in advance and resides or stays at the place.

Still further, it is an object of the invention to provide a system which gives the information supplier a charge or fee for provision of the information at the place.

According to a first aspect of the invention, there is provided an information system which comprises a first terminal which receives information related to a present location of an information supplier, a second terminal which supplies information related to a specific location to an information requester, and a server which is connected to the first terminal and the second terminal. The server comprises a storage unit which stores information supplier information including identifiers the information suppliers and the present locations of the information suppliers and a transmission unit which generates a list of the information suppliers by referring to the information supplier information and transmits the list to the second terminal, in response to a request from the information requester. The second terminal comprises a display unit which displays the transmitted list of the information supplier information, and a select unit which is used by the information requester to select a specific information supplier from the list of the information suppliers. Furthermore, the server controls to connect the first terminal of the information supplier selected by the information requester to the second terminal of the information requester.

According to a second aspect of the invention, there is provided a method of supplying information performed at an information system including a first terminal of an information supplier, a second terminal of an information requester, and a server connected to the first terminal and the first terminal. The method comprises the steps of (1) generating, at the server, a list of information suppliers by referring to stored information supplier information including identifiers of the information suppliers and present locations of the information suppliers, (2) sending, at the server, the list of the information suppliers to the second terminal in response to a request of the information requester, (3) displaying, at the second terminal, the list of the information suppliers and making the information requester possible to select one of the information suppliers from the list, and (4) controlling, at the server, to connect the first terminal corresponding to the selected information supplier and the second terminal of the information requester.

According to a third aspect of the invention, there is provided a terminal of an information supplier included in an information system including a terminal of an information requester and a server connected to the terminals. The terminal comprises an input unit which inputs information related to a present location of the information supplier, a notifying unit which notifies the server of identifier of the information supplier and the present location of the information supplier, at a predetermined timing, and a transmission unit which transmits the information related to the present location to the terminal of the information requester in response to a request of the information requester.

According to a fourth aspect of the invention, there is provided a terminal of an information requester included in an information system including a terminal of an information supplier and a server connected to the terminals. The terminal comprises an receiving unit which receives a list of information suppliers generated by referring to information supplier information including identifiers of the information suppliers and present locations of the information suppliers, from the server, a displaying unit which displays the list of information suppliers, a selecting unit which makes the information requester possible to select a specific information supplier from the list, and an information displaying unit which receives information related to the present location of the selected information supplier from the terminal of the information supplier, and displays the information on a display device of the terminal of the information requester in response to a request of the information requester.

According to a fifth aspect of the invention, there is provided a server in an information system including a terminal of an information supplier and a terminal of an information requester who wants to gain information from the information supplier. The server comprises a storage unit which receives information supplier information including an identifier of the information supplier and a present location of the information supplier from the terminal of the information supplier, and stores the information supplier information, a transmission unit which generates a list of information suppliers by referring to the information supplier information and transmits the list to the terminal of the information requester in response to a request of the information requester, and a connection control unit which, when the information requester selects a specific information supplier from the list, controls to connect the terminal of the selected information supplier to the terminal of the information requester.

According to a sixth aspect of the invention, there is provided a recording medium readable by a computer, tangibly embodying a program of instructions executable by the computer to perform a method of supplying information performed at an information system including a first terminal of an information supplier, a second terminal of an information requester, and a server connected to the first terminal and the first terminal. The method comprises the steps of (1) generating, at the server, a list of information suppliers by referring to stored information supplier information including identifiers of the information suppliers and present locations of the information suppliers, (2) sending, at the server, the list of the information suppliers to the second terminal in response to a request of the information requester, (3) displaying, at the second terminal, the list of the information suppliers and making the information requester possible to select one of the information suppliers from the list, and (4) controlling, at the server, to connect the first terminal corresponding to the selected information supplier and the second terminal of the information requester.

According to a seventh aspect of the invention, there is provided a computer data signal embodied in a carrier wave and representing a sequence of instructions which, when executed by a processor, cause the processor to perform a method of supplying information performed at an information system including a first terminal of an information supplier, a second terminal of an information requester, and a server connected to the first terminal and the first terminal. The method comprises the steps of (1) generating, at the server, a list of information suppliers by referring to stored information supplier information including identifiers of the information suppliers and present locations of the information suppliers, (2) sending, at the server, the list of the information suppliers to the second terminal in response to a request of the information requester, (3) displaying, at the second terminal, the list of the information suppliers and making the information requester possible to select one of the information suppliers from the list, and (4) controlling, at the server, to connect the first terminal corresponding to the selected information supplier and the second terminal of the information requester.

According to an eighth aspect of the invention, there is provided a program product comprising, computer readable instructions and a recording medium bearing the computer readable instructions; the instructions being adaptable to enable a computer to perform a method of supplying information performed at an information system including a first terminal of an information supplier, a second terminal of an information requester, and a server connected to the first terminal and the first terminal. The method comprises the steps of (1) generating, at the server, a list of information suppliers by referring to stored information supplier information including identifiers of the information suppliers and present locations of the information suppliers, (2) sending, at the server, the list of the information suppliers to the second terminal in response to a request of the information requester, (3) displaying, at the second terminal, the list of the information suppliers and making the information requester possible to select one of the information suppliers from the list, and (4) controlling, at the server, to connect the first terminal corresponding to the selected information supplier and the second terminal of the information requester.

### BRIEF DESCRIPTION OF THE DRAWINGS

FIG. 1 shows a diagram of an information system according to a first embodiment of the invention;

FIG. 2 shows a flowchart describing operation of the information system shown in FIG. 1;

FIG. 3 shows a flowchart describing a charge operation and a payment operation for a person who wants to get information in the information system shown in FIG. 1;

FIG. 4 shows a diagram of an information service menu which is a first level menu of the information system shown in FIG. 1;

FIG. 5 shows a diagram of another information service menu which is a second level menu of the information system shown in FIG. 1;

FIG. 6 shows a diagram of an information service menu which is a third level menu of the information system shown in FIG. 1;

FIG. 7 shows a diagram of a screen used to perform an information service start determination request of the information system shown in FIG. 1;

FIG. 8 shows a flowchart describing operation of the information system according to a second embodiment of the invention;

FIG. 9 shows a flowchart describing a charge operation and a payment operation for a person who want to get information in the information system according to the second embodiment of the invention;

FIG. 10 shows another flowchart describing a charge operation and a payment operation for a person who want to get information;

FIG. 11 shows a diagram representing an example of configuration of a computer used as a user terminal of the information system of the invention; and

FIG. 12 shows a diagram representing an example of configuration of a mobile phone used in the information system of the invention.

### DESCRIPTION OF THE PREFERRED EMBODIMENT

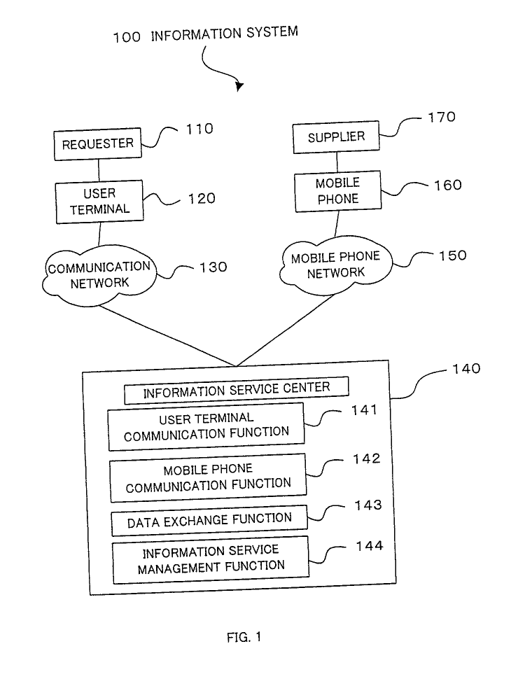

At first, description is made about an information system according to a first embodiment of the invention with reference to FIG. 1.

The information system 100 shown in FIG. 1 includes a person who wants to get information (hereinafter, referred to as an “information requester”) 110, a user terminal 120, a communication network 130, an information service center 140, a mobile phone network 150, a mobile phone 160, and an information supplier 170.

The information requester 110 manipulates the user terminal 120 and receives information service from the information service center 140 via the user terminal 120.

The user terminal 120 is an information processing device such as a mobile phone or a personal computer and includes user interface with the information requester 110, for example, a display device, buttons, a microphone, and a loudspeaker. Also, the user terminal 120 communicates with the information service center 140 via the communication network 130 and has a communication function to transfer information from the information service center 140 to the information requester 110. The communication function also includes, as described later in connection with another information system according to a second embodiment of the invention, a function to communicate from the communication network 130 to the mobile phone 160 directly, via the mobile phone network 150.

The communication network 130 includes a communication line of the Internet, an intranet, a dedicated line, a public telephone network, LAN, and WAN. The communication network 130 is used to communicate data between the user terminal 120 and the information service center 140.

The information service center 140 includes a user terminal communication function 141, a mobile phone communication function 142, a data exchange function 143, and an information service management function 144.

The user terminal communication function 141 achieves and manages communication between the information service center 140 and the user terminal 120 via the communication network 130.

The mobile phone communication function 142 achieves and manages communication between the information service center 140 and the mobile phone 160 via the mobile phone network 150.

The data exchange function 143 mainly executes the following functions. (1) A first function is to create a menu used to provide the information requester 110 with information service and supply the menu. (2) A second function is to receive an instruction about information required by the information requester 110 and send the instruction to the information supplier 170. (3) A third function is to manage data communication between the information requester 110 and the information supplier 170.

The information management function 144 mainly executes the following functions. (1) A first function is to manage a charge operation and a payment operation about a fee of using a mobile phone between the information service center 140 and the information supplier 170. (2) A second function is to manage a charge operation and a payment operation about a fee of using an information service used by the information requester 110. (3) A third function is to manage a charge operation and a payment operation of an information supplying fee to be paid to the information supplier 170. (4) A fourth function is to manage various information about the information requester 110, such as a name, an address, a telephone number, a bank account from which the fee of using the information service is paid. (5) A fifth function is to manage various information about the information supplier 170, such as a name, an address, a telephone number, a bank account to which the fee of using the information service is paid, a present location of the information supplier 170, types of information that the information supplier 170 can supply (for example, a moving picture, a still image, a sound, or characters), a reliability of information supplied by the information supplier 170, an information supplying fee of information supplied by the information supplier 170, and a profile of the information supplier 170 disclosed to the information requester 110. (6) A sixth function is to manage the whole information system.

The mobile phone network 150 is used to communicate between the information service center 140 and the mobile phone 160 used by the information supplier 170.

The mobile phone 160 is a mobile phone having a radio communication function which is capable of communicating via the mobile phone network 150. Herein, in addition to a mobile phone having a general voice call function, a mobile terminal including a microphone and a camera having CCD or C-MOS image sensor, or a mobile terminal having a character input function can be categorized as the mobile phone 160.

Also, these types of mobile phone 160 basically has a communication function to send voice data, and image data captured by a CCD camera or sound data recorded by a microphone, to the information service center 140 via the mobile phone network 150. Even if the mobile phone 160 itself does not have the communication function, the voice data and the image data can be sent to the information service center 140 by connecting the mobile phone 160 to a device having a communication function.

Hereinafter, to clarify explanation, it is assumed that the information supplier 170 is a person who has the mobile phone 160 and supplies information about a present location of the person. But, the information supplier 170 is not limited to above mentioned typical supplier, as long as the information supplier 170 can supply data related to a location. For example, the information supplier 170 can supply a scene or a situation which is seen from a window of the supplier's house, by using a personal computer located in the house. In this case, a public telephone network or the Internet is included in the mobile phone network 150 shown in FIG. 1.

The information supplier 170 supplies information obtained around the supplier and communicates required data to the information service center 140 via the mobile phone 160.

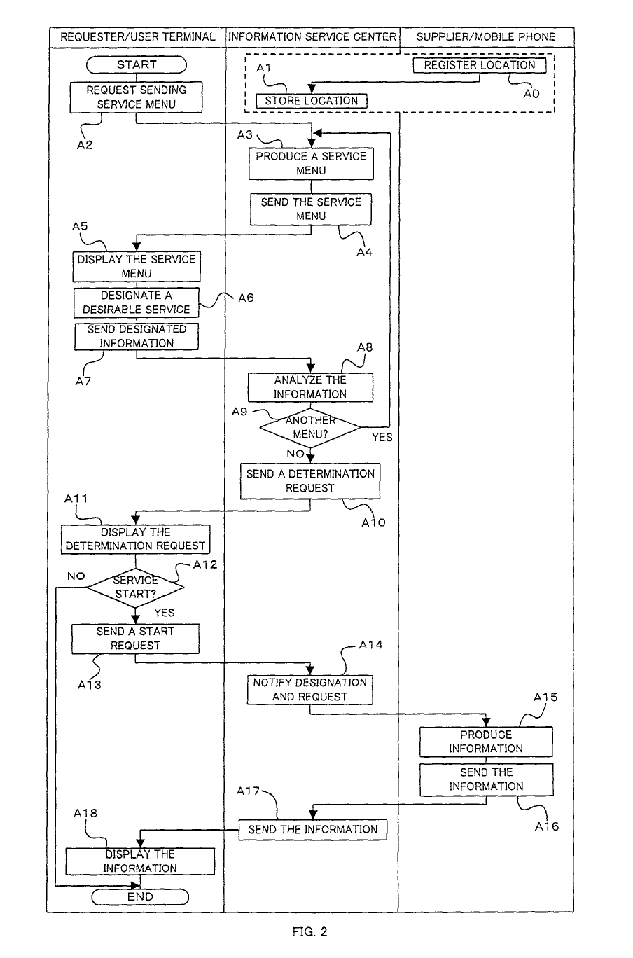

Next, operation of the information system 100 is explained with reference to FIG. 2.

In FIG. 2, operations are shown for each element in the information system 100, that is the information requester 110/the user terminal 120, the information service center 140, and the information supplier 170/the mobile terminal 160. And the order of each operation is shown with relation to the other operation. Operation of the user terminal 120 is started by a manipulation or an instruction of the information requester 110. Operation of the mobile terminal 160 is generally started by a manipulation or an instruction of the information supplier 170, but may be automatically started (without human's manipulation) when the previous operation is completed. Hereinafter, excepting for when there is a special description, it is assumed that each operation is automatically started without human's operation.

At first, in response to a manipulation of the information supplier 170 or a request of the information service center 140, or automatically, the mobile phone 160 informs the information service center 140 of location information representing a present location of the information supplier 170 (step A0). When the information service center 140 receives the location information and stores it to a predetermined storage device (step A1). All the mobile phones 160 informs the information service center 140 of such the location information. When the mobile phone automatically informs of the location information, the information may be sent to the information service center 140 in a predetermined timing or interval. Alternatively, when the mobile phone 160 moves, the information may be sent to the information service center 140. For example, the mobile phone 160 may be set to automatically send its own location information at intervals of a minute.

Also, these operations (steps A0, A1) are independent of a series of steps (steps A2-A18) described later, and can be performed before the series of steps or performed on the way of the series of steps. Therefore, these operations are shown separately from the other operations by surrounding with dotted line.

On the other hand, the information requester 110 requests the information service center 140 to send an information service menu by manipulating the user terminal 120 (step A2). In response to the request, the information service center 140 produces the information service menu based on the location information of each mobile terminal 160 at this timing (step A3), and sends the information service menu to the user terminal 120 (step A4). The information service center 140 can effectively produces the information service menu using the above mentioned and registered location information of the information suppliers 170. For example, the information service center 140 determines the number of the registered location information for each area, groups each location information into the corresponding area, and then lists the areas in the information service menu in the order of the number of the location information. Also, the information service center 140 can groups the location information and arrange the grouped information in the information service menu, based on a predetermined information regardless of the registered location information.

Then the user terminal 120 receives the information service menu from the information service center 140, and display it on a display device (screen) of the user terminal 120 (step A5).

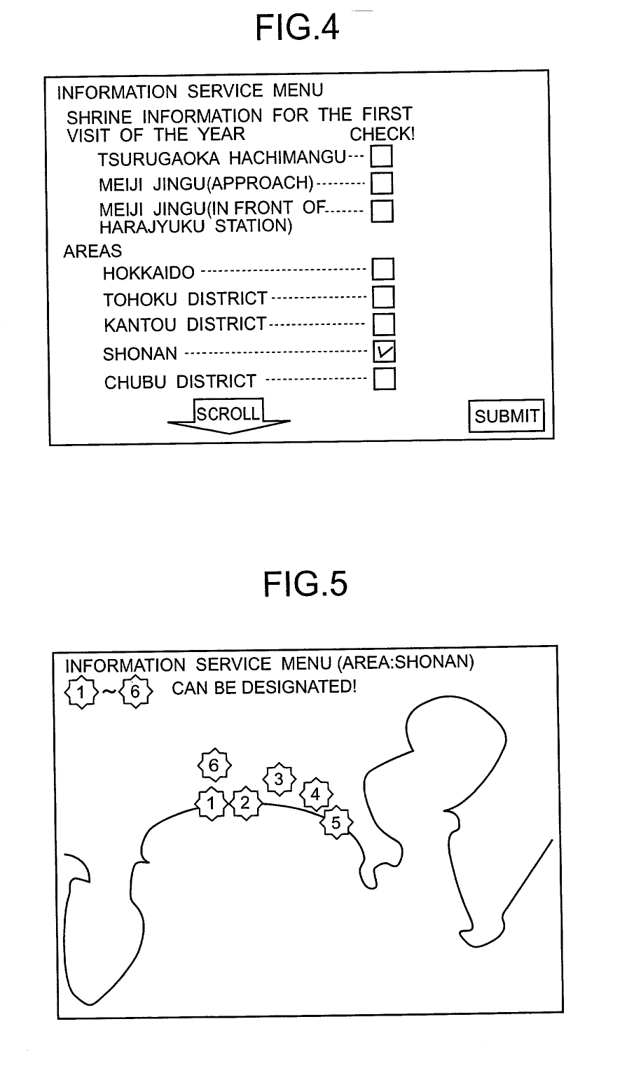

As shown in FIG. 4, the information requester 110 selects and checks a check box from a plurality of check boxes each of which corresponds to an information service (item) and is displayed in an information service menu. And then, the information requester 110 presses or pushes a submit button located in the lower right of the information service menu.

In the upper part of the information service menu, three items are shown each of which gives information about shrine where people pay their first visit of the year. Also, in the lower part of the menu, some area names are shown to select a desirable information service geographically.

Operations of such checking the check box and pushing the submit button are done, in general, by using a keyboard or a mouse connected to a personal computer. Other check boxes corresponding to other information services can be displayed by scrolling the information service menu. The menu can be scrolled by clicking a scroll button using the mouse or by pushing a down arrow key of the keyboard.

These operations are, of course, also performed by using a mobile terminal such as a mobile phone. In this case, for example, at first, only a check box displayed in the top of the information service menu shown in FIG. 4, and the corresponding information service (“Tsurugaoka Hachimangu”, a famous shrine in Japan) are displayed on a display device of the mobile phone.

The check box is preferably highlighted. In this situation, for example, when a predetermined button of the mobile phone is pushed, the check box is checked. Alternatively, when a down arrow button is pushed, the next check box corresponding to the other information service is displayed without checking the previous check box.

If the information requester 110 want to select another information service (another item), that is, to scroll the item, the information requester 110 can make the mobile phone display another item by pushing a down arrow button of the mobile phone.

Thus, the information requester 110 can make the mobile phone display a new item one after another by pushing a down arrow button of the mobile phone.

Returning to FIG. 2, the information requester 110 designates the desirable information service (item) as described above, that is, pushes the submit button (step A6) after checking a check box corresponding to the desirable information service. Then the user terminal 120 sends information about the designation (designation information) to the information service center 140 (step A7).

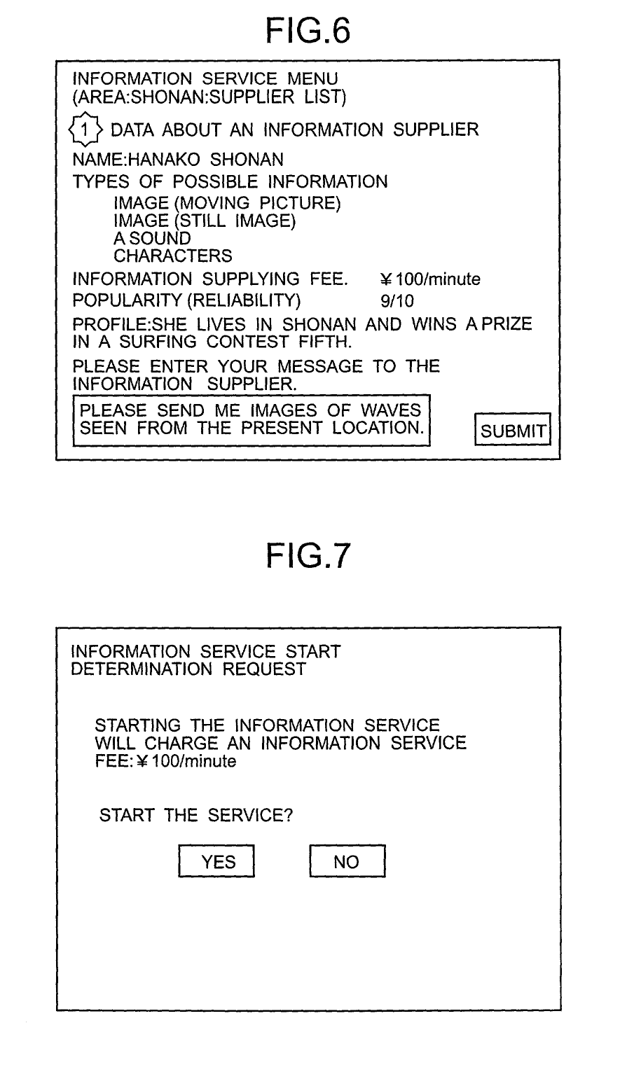

Next, the information service center 140 analyses the designation information sent from the user terminal 120 (step A8), and determines whether or not another information service menu is further required for the information requester 110 (step A9). If required, the information service center 140 produces other information service menus as shown in FIGS. 5 and 6 (step A3), otherwise, sends an information service start determination request to the user terminal (step A10). As long as an information service menu to be displayed is exist, processes from step A3 to step A9 are repeated.

Herein, the information service menu shown in FIG. 5 is displayed after, in the information service menu of FIG. 4, a check box corresponding to an information service “Shonan”, where is a famous shore to serf in Japan, is checked and the submit button is pushed. In FIG. 5, a plurality of positions of information suppliers 170 in the shore “Shonan” are shown. From FIG. 5, it is found that there are six information suppliers 170 in the shore “Shonan” and present locations of the suppliers 170 are denoted by the corresponding number each of which is surrounded by a star shape frame. Herein, the number is referred to as a “star number”.

When the information service menu of FIG. 5 is displayed on a display device of the user terminal 120, the information requester 110 designates one of the information suppliers 170 (one of the star numbers “1” to “6”) in the same way as the information service menu of FIG. 4, and the designation information is sent to the information service center 140 (steps A6, A7).

When an information supplier 170 is designated by the information requester 110 in the information service menu of FIG. 5, it is determined that another information service menu is further displayed (step A8). Then, an information service menu shown in FIG. 6 is displayed on the display device of the user terminal 120 (step A3).

Herein, it is assumed that the information supplier 170 corresponding to star number “1” is designated.

In the information service menu shown in FIG. 6, a name of the designated information supplier 170, types of information which the supplier can supply, a fee of supplying information, a degree of popularity (reliability), and a profile of the supplier are shown. In addition, a comment area is arranged to enter messages of the information requester 170 to the information supplier 170.

The types of information includes, for example, images (a moving picture, a still image), a sound, and characters. For instance, the images are input by a CCD camera and sent by using a communication function of a mobile phone. A sound is, in general, transferred by a call function commonly used in a mobile phone. Also, in addition to a sound of a call by a person, a sound of wave or a sound of crowds in a city can be transferred. Characters can be entered by using numeric buttons or a pen of a mobile phone or a mobile terminal, and transferred by the communication function of the mobile phone.

The popularity is obtained by accumulating evaluations of the previous information from the information supplier. For example, data representing how the information requester 110 satisfies the information from the information supplier or how accurate the information is, are stored for each information supplier. The data are then averaged on a maximum scale of ten points, and presented as a reliability of information. The data are stored, for example, into a storage device of the information service center 140.

Such the presentation of the evaluation is also used to evaluate a reliability of seller in an auction performed on a network.

When the information requester 110 pushes a submit button in the lower right in the information service menu shown in FIG. 6 after entering the messages in the comment area, the designation is sent to the information service center 140 as designation information (steps A6, A7). In response to sending the designation information, the information service center 140 determines that another information service menu is not required unlike the entrance from the information service menu of FIG. 5 (step A9). Then, the information service center 140 sends the information service start determination request to the user terminal 120 (step A10).

Next, the user terminal 120 displays the information service start determination request (screen) sent from the information service center 140 on the display device of the user terminal 120 as shown in FIG. 7 (step A11). The information requester 110 looks at the contents of the request as shown in FIG. 7 and determines whether the information service is started or not (step A12).

If the information requester 110 pushes “NO” button displayed in the lower right of the display device (NO in step A12), the information service is ended. On the other hand, if the information requester 110 pushes “YES” button displayed in the lower right of the display device (YES in step A12), the user terminal 120 sends the information service start request to the information service center 140 (step A13). Also, such the sending of the information service start request from the user terminal 120 can prevent carelessly accessing the information supplier 170. But, the process can be omitted in view of clarity of operations of the system.

When the information service center 140 receives the information service start request from the user terminal 120, the information service center 140 notifies the mobile phone 160 of designation of request information that the information requester 110 wants to know and requests the mobile phone 160 to supply information about the request information to the information service center 140 (step A14). Then, the information service center 140 stores data in advance to identify and access the designated information supplier 170 (for example, a telephone number). In the request information, data are included which are entered into the comment area of the information service menu shown in FIG. 6 by the information requester 110. The information service center 140 sends the request information and request to the mobile phone 160 by, for example, calling a telephone number of the mobile phone 160.

When the mobile phone 160 receives the request information and request of supplying from the information service center 140, the mobile phone 160 informs the information supplier 170 of the request information. The information supplier 170 produces the information about the request information using the mobile phone 160, in response to reception of the request information (step A15). Then, the information supplier 170 sends the produced information to the information service center 140 using the mobile phone 160 (step A16).

As described above in connection with FIG. 6, types of information which the information supplier can supply are, for example, images (a moving picture, a still image), a voice, and characters. The images are image data which are input by a CCD camera connected to the mobile phone or are captured into the mobile phone by some ways. A voice is voice data which are given by calling from the information supplier 170 via the mobile phone, or are recorded into the mobile phone via a microphone. The characters includes text data which are input by using character keys of the mobile phone or are loaded from an external device.

The type of information may be limited for an information supplier 170 since the supplier 170 lacks some devices to input the information. For example, if the information supplier 170 does not have CCD camera, the supplier 170 can not supply the image data. But, such the capability of the supplier 170 can be seen for the information requester 110 in advance by referring to the information service menu shown in FIG. 6.

When the information service center 140 receives the supplied information from the mobile phone 160, the information service center 140 sends the information supplied from the mobile phone 160 to the user terminal 120 (step A17).

When the user terminal 120 receives the supplied information from the information service center 140, the user terminal 120 transmits the supplied information to the information requester 110 in a proper way corresponding to the type of the supplied information (step A18). For example, if the information supplied from the information service center 140 is a moving picture, the moving picture is reproduced on the display device of the user terminal 120. If the information is supplied in a form of a sound, the information is output via a loudspeaker of the user terminal 120. Therefore, the user terminal 120 can reproduce of treat the supplied information (data). But, the supplied information can be stored via the user terminal 120 and the stored information can be reproduced by the other suitable device.

Then, the information requester 110, as required, can receives the information from the same information supplier again, by performing the same procedure. Also, the information requester 110 can receive information from another information supplier 170 by designating the different supplier in the information service menu shown in FIG. 5.

Further, communication data between the user terminal 120 and the information service center 140 is done by using any communication protocol such as TCP/IP. Also, communication data between the information service center 140 and the mobile phone 160 is done, in general, by using a protocol including a packet communication method and WAP.

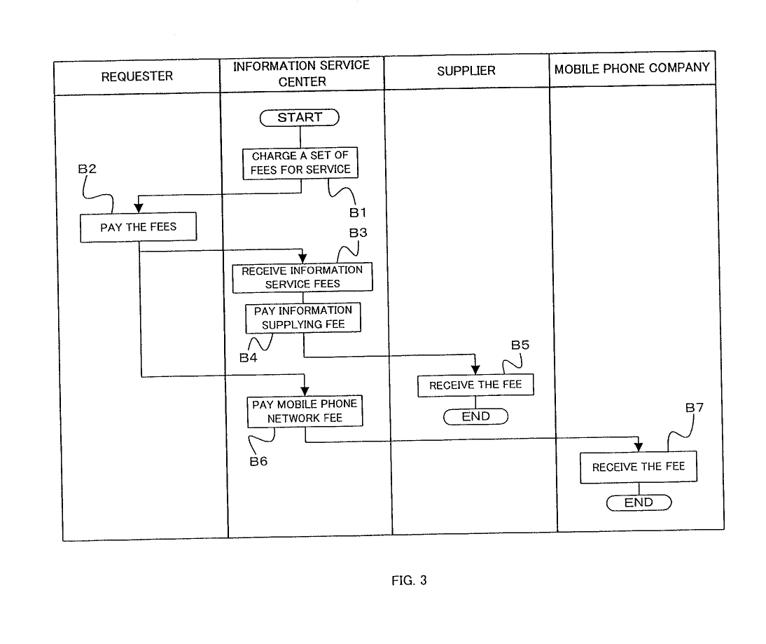

Next, description is made about a charge operation and a payment operation of the first embodiment of the invention, with reference to FIG. 3.

The information service center 140 charges the information requester 110 a set of fees about the information services (step B1), when at least one information service is given to the information requester 110 (steps A13-A18 in FIG. 2).

The set of fees about the information services specifically includes an information service fee (which means a fee of the system), an information supplying fee (which means a consideration of the supplying by the information supplier 170), and a mobile phone network fee (which means a telephone charge of calling from the information service center 140 to the mobile phone 160 of the information supplier 170). Such the mobile phone network fee is, in general, calculated based on a connection time between a calling terminal and a receiving terminal.

The information requester 110 pays the set of the fees about information services to the information service center 140 in response to the charge (step B1) sent from the information service center 140 (step B2).

The information requester 110 can pays them via a bank account for automatic payment. For example, the requester 110 establishes the bank account in advance and notifies the information service center 140 of the bank account. Then the information service center 140 calculates a fee of using the information services, produces a record to charge the fee from the bank account, and sends the record to a predetermined network with a predetermined protocol.

Alternatively, payment to a designated account by the information requester 110 can be fostered, by sending a bill data from the information service center 140 to the user terminal 120. Further, the service center 140 can post the information requester 110 a bill to foster payment.

Furthermore, an electrical money such as “Mondex” and “BitCash” can be used to pay the fee rather than a payment to a bank account or a payment by a postal order.

Next, the information service center 140 receives the information service fee as a fee for the system, from the charge demanded for the information requester 110 (step B3). And the information service center 140 pays the information supplying fee as a consideration of the supplying by the information supplier 170 to the information supplier 170 (step B4). Then, the information supplier 170 receives the information supplying fee (step B5).

Also, the information service center 140 separates the mobile phone network fee from the charge demanded for the information requester 110 and pays the fee to a mobile phone company (step B6). Then, the mobile phone company receives the fee (step B7).

Further, method of charging can be established without considering the mobile phone network fee demanded for the information service center 140, or so as to include the mobile phone network fee in the information service fee.

Next, description is made in more detail about operation of the first embodiment of the invention. Herein, it is assumed that the information requester 110 is a surfer and he/she want to know a state of waves in “Shonan” shore to determine whether he/she goes surfing in the shore or not.

The surfer (the information requester 110) selects an item “Shonan” from the information service menu which is shown in FIG. 4 and sent from the information service center 140. And he/she further selects one information supplier 170 who presents near a shoreline from a plurality of information suppliers 170, each of who is denoted by a star number, displayed in the information service menu which is shown in FIG. 5 and is displayed after the selection in the menu of FIG. 4. Herein, it is assumed that the surfer selects an information supplier 170 denoted by a star number “1”.

Then, the surfer can see data about the information supplier 170 denoted by the star number “1” by referring to the information service menu shown in FIG. 6. Consequently, it is found that the information supplier is Hanako, she can supply all types of information, that is, images, a sound, and characters, an information supplying fee is 100 yen per minute, and a popularity (reliability) is nine points on a maximum scale of ten points. From the popularity of her, the surfer can see that the information supplier is fairly reliable.

Also, from a profile, it is found that she lives in “Shonan” and knows a lot about surfing. Therefore, the surfer can expects that information specific to the area and information about waves in a special view can be obtained.

In addition, the surfer can designate information to be supplied from the information supplier 170 in detail by describing a comment in the comment area arranged in the bottom of the information service menu of FIG. 6. The surfer can use technical terms of surfing in the comment and can ask a question about a special matter requiring high level knowledge of surfing, since it has been found that the information supplier 170 knows a lot about surfing from the profile.

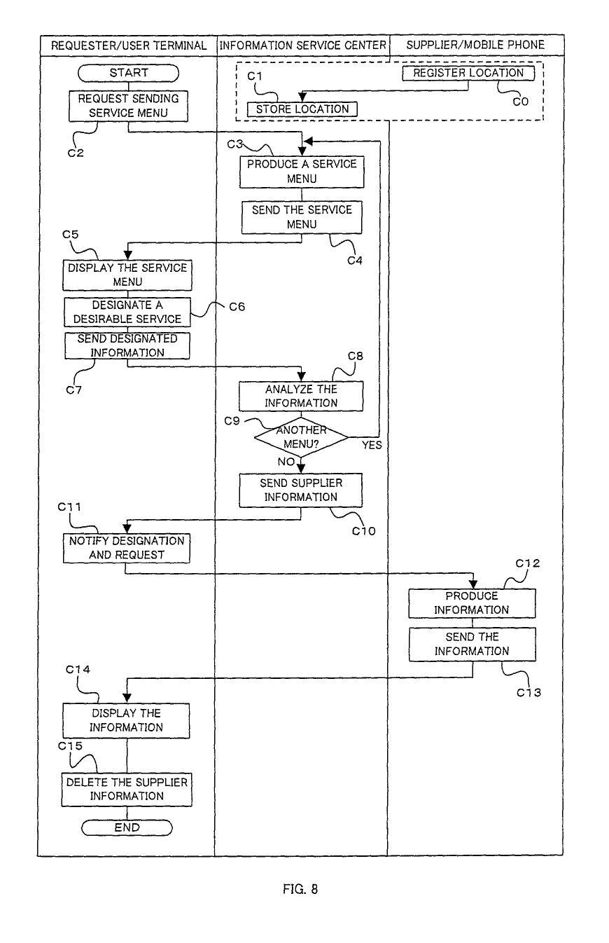

Next, description is made about a second embodiment of the invention with reference to FIG. 8. A flowchart of FIG. 8 is almost the same as the flowchart of FIG. 2, but in FIG. 8, communication between the information requester 110 (the user terminal 120) and the information supplier 170 (the mobile phone 160) is performed not through the information service center 140. That is, steps A0-A9 in FIG. 2 are the same as steps C0-C9 in FIG. 8. Therefore, hereinafter, description is made only about processes after step C10.

In the second embodiment of the invention, in step C10, the information service center 140 sends an information supplier information to the user terminal 120 to commence an information service. The information includes data to directly access from the user terminal 120 to the mobile terminal 160. In specifically, the information includes an IP address or a telephone number of the user terminal 120, or a telephone number of the mobile phone 160. As described above, after step C10, the information service center 140 does not relate to communication between the user terminal 120 and the mobile phone 160.

In step C11, when the user terminal 120 receives the information supplier information from the information service center 140, the user terminal 120 notifies the mobile phone 160 of designation of request information that the information requester 110 wants to know and requests the mobile phone 160 to supply information about the request information to the user terminal 120. Unlike the first embodiment, the information service start determination request screen shown in FIG. 7 is not displayed on a display device of the user terminal 120, but the information service start determination request screen can be displayed in the same way as the first embodiment and the information requester 110 can finally determines starting of the information service.

The notification of the request information and the request for supplying information are, for example, performed by directly calling from the user terminal 120 to the mobile phone 160.

Next, when the mobile phone 160 receives the request information and request for supplying information, the mobile phone 160 informs the information supplier 170 of the request information from the user terminal 120. That is, the information supplier 170 produces information which responds to the received request information by using the mobile terminal 160 (step C12) and sends the produced information to the user terminal 120 (step C13).

Then, the user terminal 120 transfers the supplied information from the mobile terminal 160 to the information requester 110 through images, a sound, or characters (step C14). After that, transmission of information is repeated between the user terminal 120 and the mobile phone 160 according to a requirement of the information requester 110.

The transmission of the information is performed between the user terminal 120 and the mobile phone 160 without using the information service center 140. For example, in general, data are exchanged by calling from the user terminal 120 to the mobile phone 160, as described above. However, information stored in a server on the Internet by using a packet communication method or a protocol such as WAP, are accessed by the user terminal 120 via a public telephone network or the internet using a protocol such as TCP/IP.

When the information service given between the information requester 110 and the information supplier 170 is completed (steps C11-C14), the user terminal 120 deletes the information supplier information stored in the user terminal 120 (step C15) so that the information requester 110 does not access the information supplier 170 without using the information service center 140 at the next information service. Also, at the same time, history data stored in the mobile phone 160 can be deleted as required.

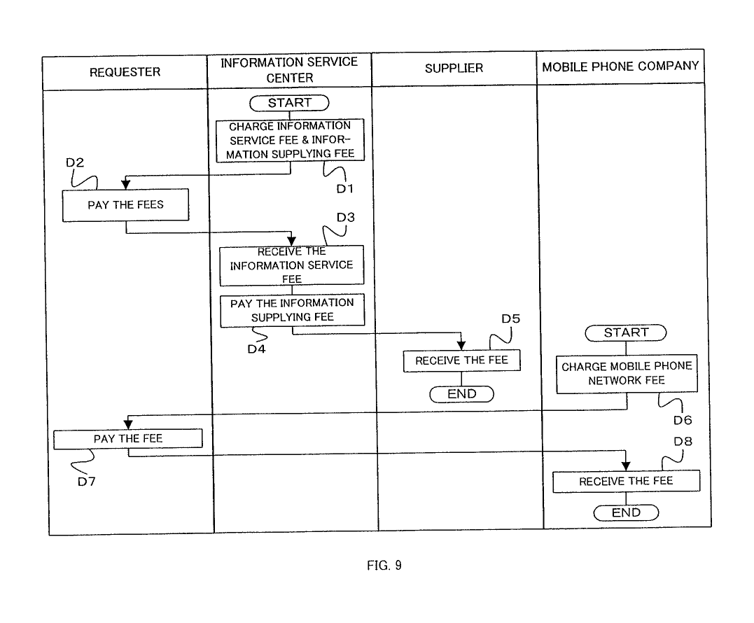

Next, description is made about a charge operation and a payment operation about the information requester 110, with reference to FIG. 9. The information service center 140 charges the information requester 110 an information service fee and an information supplying fee when the information service is supplied to the information requester 110.

The information requester 110 pays the information service fee and the information supplying fee to the information service center 140 (step D2).

Then, the information service center 140 receives the information service fee as a fee for the system from the payment (step D3). And the information service center 140 passes the received information supplying fee to the information supplier 140 as a consideration for supplying effective information (step D4). The information supplier 170 receives the information supplying fee (step D5).

Steps D6-D8 described later can be performed independence of operations of steps D1-D5. In FIG. 9, these steps D6-D8 are denoted after step D5 for convenience, but the steps D6-D8 are not required to be performed after step D5.

The mobile phone company charges the information requester 110 a mobile phone network fee (step D6) since the information requester 110 (user terminal 120) uses a mobile phone network for connecting to the mobile phone 160.

The information requester 110 pays the charged mobile phone network fee to the mobile phone company (step D7) and the company receives the fee (step D8).

Many types of variations can be thought of for the charge operation and the payment operation as described in connection with FIG. 3.

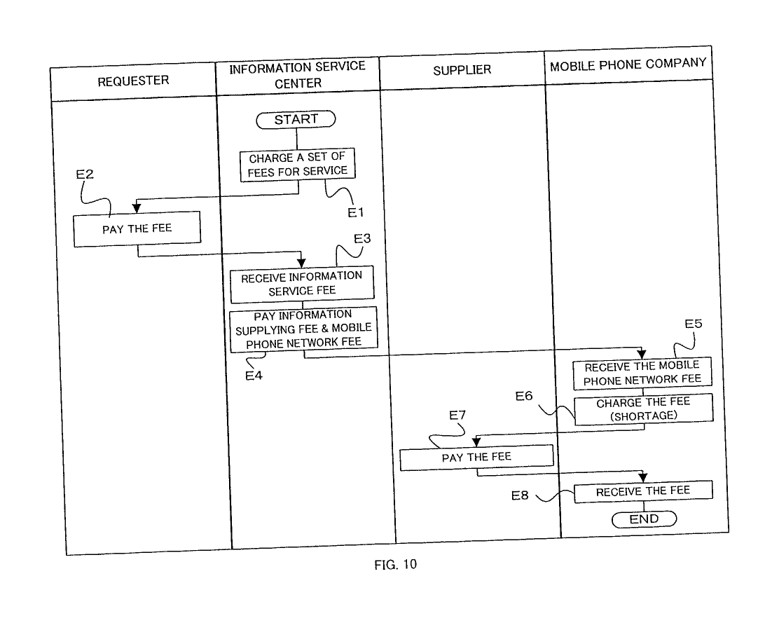

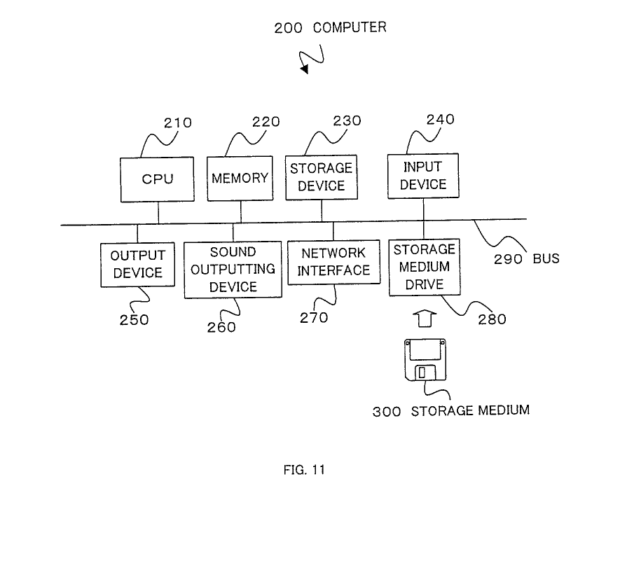

Next, another charge operation and another payment operation are illustrated with reference to FIG. 10.

At first, the information service center 140 charges the information requester 110 a set of fees about the information services (step E1), and the information requester 110 pays the set of fees to the information service center 140 (step E2). And then, the information service center 140 receives an information service fee as a fee for the system from the set of fees (step E3) and pays the remaining fees to the mobile phone company as an information supplying fee and a mobile phone network fee (step E4).

The mobile phone company receives a part of the payment from the information requester 110 as the mobile phone network fee for the information requester 110 (user terminal 120) (step E5). Further, the mobile phone company receives the remaining of the payment as a mobile phone network fee for using a service other than the information service by the information supplier 170. If there is a shortage, the information supplier 170 must pay the shortage as the mobile phone network fee (step E6). On the contrary, if the remaining of the payment is larger than the mobile phone network fee for using the service other than the information service, the difference is paid to the information supplier 170.

The information supplier 170 pays the mobile phone network fee charged by the mobile phone company, to the mobile phone company (step E7), the mobile phone company receives the payment (step E8). The operations shown in FIG. 10 are different from a common payment method and rather, are similar to an electricity selling system. Therefore, it is required that the information supplier 170 and the mobile phone company agree to the payment method.

Also, there may be some situation about the charge operation and the payment operation. In a case, the information service center 140 and the mobile phone company belong to the same company or the information supplier 170 is an employee of the information service center 140.

In another case, the information supplier is an employee of the mobile phone company, or the information service center 140 and the mobile phone company belong the same company and the information supplier 170 is an employee of the company.

In still another case, the information supplier 170 belongs a company such as an information providing company which employs one or more information suppliers 170 and is different from the mobile phone company.

Next, description is made about a configuration of a computer used for the user terminal 120 of the invention with reference to FIG. 11. Herein, it is assumed that the user terminal 120 is a desktop personal computer, but the terminal 120 as described above, is limited to the type of computer and may be configured of a various of types of computers including a mobile terminal.

A computer 200 shown in FIG. 11 includes a CPU 210, a memory 220, a storage device 230, an input device 240, an output device 250, a sound outputting device 260, a network interface 270, a storage medium drive 280, and a bus 290. The computer 200 is, in general, a personal computer or a workstation, but other types of computer may be used as the computer 200.

The CPU 210 controls the other elements and controls a process of sending a request of an information service menu to the information service center 140 and a process of outputting an information supplied from the information supplier 170.

The memory 220 temporarily stores data required by a process in the CPU 210. Also, programs used to perform processes in the user terminal 120 are loaded into the memory 220.

The storage device 230 is an external storage device such as a hard disk.

The input device 240 is, for example, a keyboard or a mouse used to input items or instructions. Checking, inputting characters, or pushing the submit button at the information service menu as shown in FIGS. 4-6 or pushing the “YES” button or “NO” button at the information service start determination request screen shown in FIG. 7 are done by the input device 240.

The output device 250 is generally a display device consists of, for example, a CRT display. The above mentioned information service menu or the information service start determination request screen is displayed on the display device.

The sound outputting device 260 is a device to output a sound, and is typically a loudspeaker. If data supplied from the information supplier 170 includes sound data, the sound data are supplied from the loudspeaker.

The network interface 270 includes an interface function to interface with a network, and connects to the information service center 140 or the mobile phone 160 via the communication network 130 or the mobile phone network 150.

The storage medium drive 280 reads data from a storage medium 300 such as a floppy disk, a CD-ROM, and a DVD-ROM, and transfers the data to the memory 220 or the storage device 230 of the computer 200, as required. In the storage medium 300, programs to perform the information system of the invention may be included.

The bus 290 is a common transmission path to communicate information including data and commands between the elements (the CPU 210 through the storage medium drive 280).

Such the configuration of computer 200 can be also used as the information service center 140. In this case, the CPU 210 mainly controls the operations of functions 141-144 of the information service center 140.

In the storage device 230, the location information of each information suppliers 170 is stored. Also, evaluation of each information supplier 170 is accumulated and then a popularity of the information supplier 170 is generated and stored in the storage device 230.

Also, the network interface 270 communicates with the user terminal 120 via the communication network 130 and communicates with the mobile phone 160 via the mobile phone network 150, to send/receive required data.

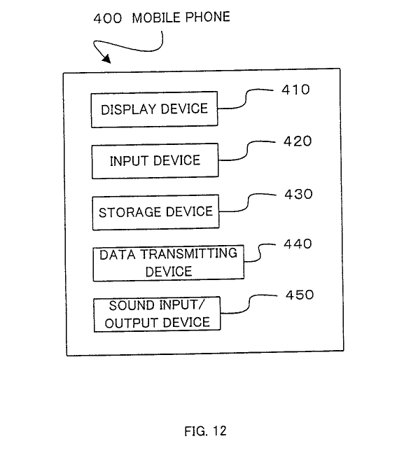

At last, description is made about a general configuration of the mobile phone 160 with reference to FIG. 12. As described above, instead of the mobile phone, desk top type computer can be used.

The mobile phone 400 shown in FIG. 12, includes a display device 410, an input device 420, a storage device 430, a data transmitting device 440, and a sound input/output device 450.

The display device 410 displays a telephone number edit screen or various statuses about the mobile phone 400 including a calling status. Also, when the mobile phone 400 receives a moving picture or a still image, the mobile phone 400 can display them on the display device 410.

The input device 420 includes a hook button, numeric buttons (“0” button-“9” button), and directional buttons (a right arrow button, a left arrow button, a down arrow button, and a up arrow button). The numeric buttons are mainly used to call, that is, to input a telephone number. By using a combination of a plurality of numeric buttons, double byte characters such as KANJI character can be entered to the mobile phone 400. Also, the directional buttons are used to instruct to move a screen displayed on the display device 410 of the mobile phone 400 or to scroll the screen. When the information supplier 170 supplies information by characters, the information supplier 170 input the characters by using the input device 420.

The storage device 430 is used to store data of a telephone book, a status of the mobile phone, and sound data. When the information supplier 170 supplies information including images, a sound, and characters, the information are generally stored in the storage device 430 temporarily and then sent to the information service center 140 or the user terminal 120 by using a predetermined protocol.

The moving picture is stored, for example, in a form of MPEG2 or MPEG4, and the still image is stored, for example, in a form of JPEG or GIF. Also, sound data may be stored in a form of MP3 or WAV, and the characters are generally stored by using ASCII code or JIS code.

The data transmitting device 440 modulates the data which includes, for example, images and are stored in the storage device 430 and sends the modulated data to the information service center 140 or the user terminal 120 via an antenna of the mobile phone 400 and base stations connected to the mobile phone network 150. On the contrary, when data are sent to the mobile phone 400, the data are sent to the mobile phone 400 in an order contrary to the above sending order, and herein, the data transmitting device 440 of the mobile phone 400 receives the received data and demodulates them. If the data are sound data, the above transmitting processes are the same as calling processes by the conventional telephones.

The sound input/output device 450 includes, in general, a microphone to input a sound and a loudspeaker to output the sound. These are mainly used to communicate between users via mobile phones. Further, if the information supplier 170 want to give a sound around a present location of the information supplier 170, the information supplier 170 can give the sound as a live sound by using the microphone. Also, the information supplier 170 can indirectly give the sound by recording the sound using the microphone of the mobile phone 400 and sending the recorded sound data.

It is a first effect of the invention to be able to get information about a desirable location in real-time. For example, it is easy to obtain local or real-time information such as a state of a shore to play surfing, the number of people waiting for a ski lift, scores of games still in progress, the number of people waiting at an amusement spot, information of a traffic jam, and weather information at a local place. The effect is very important in that it is difficult to gain such the information from the mass media.

It is also a second effect of the invention that a quality of information supplied to the information requester can be improved since the information service center controls a quality and a reliability of information supplied from the information supplier.

Further, it is a third effect of the invention that anyone having a mobile phone can be information supplier, consequently, the information requester can get a desirable information from a large amount of information source.

Still further, it is a fourth effect of the invention that an owner of the mobile phone can be easily information supplier and can earn an income.

Furthermore, it is a fifth effect of the invention that the information supplier who positively supply information is considered as a reporter of a TV program, as a result, a new employment is produced.

What is claimed is:

1. An information system comprising:
a first terminal which receives information related to a present location of an information supplier;
a second terminal which supplies information related to a specific location to an information requester; and
a server which is connected to the first terminal and the second terminal, wherein the server comprises:
a storage unit which stores information supplier information including identifiers the information suppliers and the present locations of the information suppliers; and
a transmission unit which generates a list of the information suppliers by referring to the information supplier information and transmits the list to the second terminal, in response to a request from the information requester, and wherein the second terminal comprises:
a display unit which displays the transmitted list of the information supplier information; and
a select unit which is used by the information requester to select a specific information supplier from the list of the information suppliers, and wherein the server controls to connect the first terminal of the information supplier selected by the information requester to the second terminal of the information requester.

2. The information system of claim 1, wherein, when the first terminal is connected to the second terminal, the information related to the present location of the information supplier is sent from the first terminal to the second terminal.

3. The information system of claim 2, wherein the information related to the present location of the information supplier represents a situation around the present location.

4. The information system of claim 2, wherein the information related to the present location of the information supplier includes at least one type of data selected from a group including a moving picture, a still image, a sound, and characters.

5. The information system of claim 1, wherein the server controls to connect the first terminal to the second terminal via the server.

6. The information system of claim 5, wherein the first terminal is a mobile terminal having a communication function and the connection between the first terminal and the server is made via a mobile phone network.

7. The information system of claim 6, wherein the first terminal consists of a mobile terminal having an information input function and a communication device which is separated from the mobile terminal.

8. The information system of claim 1, wherein the server controls to directly connect the first terminal to the second terminal.

9. The information system of claim 8, wherein the first terminal is a mobile terminal having a communication function and the connection between the first terminal and the second terminal is made via a mobile phone network.

10. The information system of claim 9, wherein the first terminal consists of a mobile terminal having an information input function and a communication device which is separated from the mobile terminal.

11. The information system of claim 2 further comprising a charge/payment operating unit which charges the information requester a fee according to a connection time between the first terminal and the second time or the information supplied from the first terminal to the second terminal.

12. The information system of claim 11, wherein the charge/payment operating unit controls to pay at least a part of the fee paid by the information requester to the information supplier based on a predetermined fee for supplying information.

13. The information system of claim 12, wherein if the first terminal is a mobile phone or a terminal connected to a mobile phone, the charge/payment operating unit controls to charge the information requester a fee including a mobile phone network fee and to pay the mobile phone network fee to the corresponding mobile phone company.

14. The information system of claim 2, wherein when the information related to the present location of the information supplier is sent from the first terminal to the second terminal, the information is grouped into a plurality of areas and displayed on a display device of the second terminal.

15. A method of supplying information performed at an information system including a first terminal of an information supplier, a second terminal of an information requester, and a server connected to the first terminal and the first terminal, comprising the steps of:
generating, at the server, a list of information suppliers by referring to stored information supplier information including identifiers of the information suppliers and present locations of the information suppliers;
sending, at the server, the list of the information suppliers to the second terminal in response to a request of the information requester;
displaying, at the second terminal, the list of the information suppliers and making the information requester possible to select one of the information suppliers from the list; and
controlling, at the server, to connect the first terminal corresponding to the selected information supplier and the second terminal of the information requester.

16. The method of claim 15, wherein when the second terminal and the first terminal and the second terminal are connected each other, information related to the present location of the information supplier is sent from the first terminal to the second terminal.

17. The method of claim 15, wherein the information related to the present location of the information supplier represents a situation around the present location.

18. The method of claim 15, wherein the information related to the present location of the information supplier includes at least one type of data selected from a group including a moving picture, a still image, a sound, and characters.

19. A terminal of an information supplier included in an information system including a terminal of an information requester and a server connected to the terminals, comprising:
an input unit which inputs information related to a present location of the information supplier;
a notifying unit which notifies the server of identifier of the information supplier and the present location of the information supplier, at a predetermined timing; and
a transmission unit which transmits the information related to the present location to the terminal of the information requester in response to a request of the information requester.

20. A terminal of an information requester included in an information system including a terminal of an information supplier and a server connected to the terminals, comprising:
an receiving unit which receives a list of information suppliers generated by referring to information supplier information including identifiers of the information suppliers and present locations of the information suppliers, from the server;
a displaying unit which displays the list of information suppliers;
a selecting unit which makes the information requester possible to select a specific information supplier from the list; and
an information displaying unit which receives information related to the present location of the selected information supplier from the terminal of the information supplier, and displays the information on a display device of the terminal of the information requester in response to a request of the information requester.

21. A server in an information system including a terminal of an information supplier and a terminal of an information requester who wants to gain information from the information supplier, comprising:
a storage unit which receives information supplier information including an identifier of the information supplier and a present location of the information supplier from the terminal of the information supplier, and stores the information supplier information;
a transmission unit which generates a list of information suppliers by referring to the information supplier information and transmits the list to the terminal of the information requester in response to a request of the information requester; and
a connection control unit which, when the information requester selects a specific information supplier from the list, controls to connect the terminal of the selected information supplier to the terminal of the information requester.

22. A recording medium readable by a computer, tangibly embodying a program of instructions executable by the computer to perform a method of supplying information performed at an information system including a first terminal of an information supplier, a second terminal of an information requester, and a server connected to the first terminal and the first terminal, the method comprising the steps of:
generating, at the server, a list of information suppliers by referring to stored information supplier information including identifiers of the information suppliers and present locations of the information suppliers;
sending, at the server, the list of the information suppliers to the second terminal in response to a request of the information requester;
displaying, at the second terminal, the list of the information suppliers and making the information requester possible to select one of the information suppliers from the list; and
controlling, at the server, to connect the first terminal corresponding to the selected information supplier and the second terminal of the information requester.

23. A computer data signal embodied in a carrier wave and representing a sequence of instructions which, when executed by a processor, cause the processor to perform a method of supplying information performed at an information system including a first terminal of an information supplier, a second terminal of an information requester, and a server connected to the first terminal and the first terminal, the method comprising the steps of:
generating, at the server, a list of information suppliers by referring to stored information supplier information including identifiers of the information suppliers and present locations of the information suppliers;
sending, at the server, the list of the information suppliers to the second terminal in response to a request of the information requester;
displaying, at the second terminal, the list of the information suppliers and making the information requester possible to select one of the information suppliers from the list; and
controlling, at the server, to connect the first terminal corresponding to the selected information supplier and the second terminal of the information requester.

24. A program product comprising, computer readable instructions and a recording medium bearing the computer readable instructions; the instructions being adaptable to enable a computer to perform a method of supplying information performed at an information system including a first terminal of an information supplier, a second terminal of an information requester, and a server connected to the first terminal and the first terminal, the method comprising the steps of:
generating, at the server, a list of information suppliers by referring to stored information supplier information including identifiers of the information suppliers and present locations of the information suppliers;
sending, at the server, the list of the information suppliers to the second terminal in response to a request of the information requester;
displaying, at the second terminal, the list of the information suppliers and making the information requester possible to select one of the information suppliers from the list; and
controlling, at the server, to connect the first terminal corresponding to the selected information supplier and the second terminal of the information requester.
